(19) United States
(12) Patent Application Publication
(10) Pub. No.: US 2021/0378244 A1
(43) Pub. Date: Dec. 9, 2021

(54) VIRUCIDAL COMPOSITIONS AND METHODS

(71) Applicant: InExtreme Enterprises Pty Ltd, Perth (AU)

(72) Inventor: Sergio Vitomir, New Westminster (CA)

(73) Assignee: InExtreme Enterprises Pty Ltd, Perth (AU)

(21) Appl. No.: 17/338,982

(22) Filed: Jun. 4, 2021

Related U.S. Application Data
(60) Provisional application No. 63/034,839, filed on Jun. 4, 2020.

(51) Int. Cl. A01N 47/28; A01N 33/12; A01N 25/02

(52) U.S. Cl. CPC A01N 47/28; A01N 25/02; A01N 33/12

(57) ABSTRACT

A biocidal/antiviral composition comprises a quaternary ammonium compound (QAC) in combination with a reagent that increases the cationic charge on the QAC to thereby increase the biocidal/antiviral effect of the QAC. In preferred aspects, the reagent is urea hydrochloride and the QAC is dialkyl dimethyl ammonium chloride.

This application claims priority our co-pending U.S. Provisional Patent Application with the Ser. No. 63/034,839, which was filed Jun. 4, 2020, and which is incorporated by reference herein.

### FIELD OF THE INVENTION

The field of the invention is antimicrobial compositions and methods, and particularly quaternary ammonium compound (QAC) containing compositions that comprise a synergistic enhancer for improved antiviral activity.

### BACKGROUND OF THE INVENTION

The background description includes information that may be useful in understanding the present invention. It is not an admission that any of the information provided herein is prior art or relevant to the presently claimed invention, or that any publication specifically or implicitly referenced is prior art.

All publications and patent applications herein are incorporated by reference to the same extent as if each individual publication or patent application were specifically and individually indicated to be incorporated by reference. Where a definition or use of a term in an incorporated reference is inconsistent or contrary to the definition of that term provided herein, the definition of that term provided herein applies and the definition of that term in the reference does not apply.

Disinfection of fomites is one of many critical tasks required to control spread of an infectious agent, and especially viruses. Depending on the particular species, viruses can persist infectious on a substrate for hours, days, and sometime even weeks. For example, the SARS-CoV-2 virus, the etiologic agent of COVID-19, has been reported to remain infectious on hard and smooth surfaces such as many metals and wood for 4-5 days, on most plastic and stainless steel materials for 2-3 days, and on cardboard for about 24 hours. Such relatively long persistence coupled with an extended incubation period accounts for at least part of the pervasive spread of the SARS-CoV-2 virus.

Quaternary ammonium compounds (QAC) are well known to have excellent biocidal activity in contact with a large variety of viruses, bacteria, germs, fungi, moulds, and mildew.

Moreover, most of the QACs are relatively benign to the environment and have low to no significant toxicity to human and most non-human mammals on skin contact. Among other compounds, biocidal QAC's available on the market today include alkyl dimethyl benzyl ammonium chloride, alkyl dimethyl ethyl benzyl ammonium chloride, didecyl dimethyl ammonium chloride, benzethonium chloride, myristyl ammonium chloride, dialkyl dimethyl ammonium chloride, and dialkyl methyl benzyl ammonium chloride. Earlier outbreaks of coronaviruses such as the SARS-CoV virus in Hong Kong or MERS in certain middle eastern countries afforded an opportunity for QAC-based products to demonstrate their superior virucidal effect on coronaviruses by contact. For example, one of the first products tested in Australia on the human strain of the SARS corona virus and approved for use by the WHO was formulated by this inventor. Here, the virucidal composition consisted of a mixture of two distinct QACs, dialkyl dimethyl ammonium chloride and benzalkonium chloride, at a molar ratio of 1:1 at a combined QAC concentration of 3% (w/w).

Most QACs in pure form are solid amorphous crystals, that are sticky and very difficult to handle industrially. For this reason, many manufacturers of QAC compounds will offer QACs diluted in water or diluted in a water/alcohol (isopropanol or ethanol) mixture as such forms are significantly easier to handle and dispense in metered quantities. To facilitate handling quality, QACs have also been combined with dry urea in a process in which a carrier solvent of a QAC solution is evaporated and in which the QAC was mixed with dry urea as is described in US 2013/0225456. While such process improves handling quality of the QAC, the virucidal activity of the QAC that was concentrated on or in a urea core remained unaffected.

Thus, even though various virucidal compositions and methods using QACs are known in the art, all or almost all of them suffer from several drawbacks. Therefore, there remains a need for compositions and methods for improved virucidal compositions and methods.

### SUMMARY OF THE INVENTION

The inventive subject matter is directed to various virucidal compositions and methods in which a QAC is combined with urea hydrochloride or another nitrogenous base-hydrochloride compound, preferably in synergistic quantities to so produce an antiviral composition with increased virucidal activity (as compared to the virucidal activity same QAC(s) without the urea hydrochloride or other nitrogenous base-hydrochloride).

For example, in one aspect of the inventive subject matter, the inventor contemplates a biocidal composition that includes an aqueous carrier comprising a synergistic combination of a quaternary ammonium compound (QAC) and a nitrogenous base-hydrochloride. Most typically, the nitrogenous base-hydrochloride is present in an amount relative to the QAC that increases a biocidal effect as compared to the biocidal effect of the QAC alone.

For example, in some embodiments the QAC is present in the composition in an amount of between 0.5% and 3%, and wherein the nitrogenous base-hydrochloride is present in the composition in an amount of between 1.0% and 2.5%. In other embodiments, the QAC is present in the composition in an amount of 0.9% (+/−0.2) %, and wherein the nitrogenous base-hydrochloride is present in the composition in an amount of at least 1.8%. In further embodiments, the amount of the nitrogenous base-hydrochloride that increases a biocidal effect of the QAC is between 0.75 and 3%.

With respect to suitable QACs it is contemplated that the QAC is alkyl dimethyl benzyl ammonium chloride, alkyl dimethyl ethyl benzyl ammonium chloride, didecyl dimethyl ammonium chloride, benzethonium chloride, myristyl ammonium chloride, dialkyl dimethyl ammonium chloride, and/or dialkyl methyl benzyl ammonium chloride. Suitable nitrogenous bases in the nitrogenous base-hydrochloride include urea, acetylurea, an alkanolamine, an alkoxyamines, an alkylamine, a dialkylamine, an alkyldiamine, an alkyltriamine, an alkyltetramine, and/or a trialkylamine.

Where desired, the biocidal composition may include water as the aqueous carrier and may or may not comprise a viscosity enhancing agent and/or an anionic or zwitterionic detergent. It is further contemplated that the composition is formulated for topical application to a fomite via a spray or rinse/soaking fluid. Moreover, it is generally preferred that the biocidal effect (e.g., antiviral and/or an antibacterial effect) of the composition is reduced by no more than 10% after storage of the composition over at least one year. Contemplated biocidal compositions may further include an organic cosolvent, and in at least some embodiments the biocidal composition is contained or packaged in a multi-use container having a volume of between 100 mL and 5,000 mL, where the container may optionally include a spray nozzle.

Therefore, the inventor also contemplates a method of disinfecting a surface that includes a step of applying the composition presented herein to the surface in an amount effective to reduce a quantity of infectious bacteria or viruses. Most typically, the step of applying comprises spraying, soaking, or wiping the composition onto the surface.

In still further contemplated aspects of the inventive subject matter, the inventor also contemplates a method of increasing a biocidal effect of a quaternary ammonium compound (QAC). Most typically such method includes a step of combining the QAC with a nitrogenous base-hydrochloride that increases the cationic charge on the QAC.

For example, the nitrogenous base in the nitrogenous base-hydrochloride may be urea, acetylurea, an alkanolamine, an alkoxyamines, an alkylamine, a dialkylamine, an alkyldiamine, an alkyltriamine, an alkyltetramine, and/or a trialkylamine, and/or the QAC may be alkyl dimethyl benzyl ammonium chloride, alkyl dimethyl ethyl benzyl ammonium chloride, didecyl dimethyl ammonium chloride, benzethonium chloride, myristyl ammonium chloride, dialkyl dimethyl ammonium chloride, and dialkyl methyl benzyl ammonium chloride, and wherein the reagent is urea, acetylurea, an alkanolamine, an alkoxyamines, an alkylamine, a dialkylamine, an alkyldiamine, an alkyltriamine, an alkyltetramine, and/or a trialkylamine. It is typically preferred that the nitrogenous base-hydrochloride is present in an amount relative to the QAC that increases a biocidal effect as compared to the biocidal effect of the QAC alone.

Various objects, features, aspects and advantages of the inventive subject matter will become more apparent from the following detailed description of preferred embodiments, along with the accompanying drawing.

### BRIEF DESCRIPTION OF THE DRAWING

FIG. 1 is a graph depicting antimicrobial activity of DDAC alone.

FIG. 2 is a graph depicting antimicrobial activity of DDAC in combination with BAC.

FIG. 3 is a graph depicting antimicrobial activity of DDAC at 0.9% concentration in combination with UMC at various concentrations.

FIG. 4 is a graph depicting antimicrobial activity of DDAC at various concentrations in combination with UMC at 3% concentration.

### DETAILED DESCRIPTION

The inventor has discovered that the antiviral effect of one or more QAC compounds can be unexpectedly and significantly increased by combining the QAC compound(s) with a reagent that increases the cationic charge on the QAC compound. In such combination, the antiviral effect of a QAC compound has been observed to be several-fold higher than the antiviral effect of the QAC alone. Most typically, the reagent that increases the cationic charge on the QAC compound is nitrogenous base-hydrochloride, and preferably urea hydrochloride.

While not wishing to be bound by any theory or hypothesis, the inventor contemplates that the nitrogenous base-hydrochloride will boost the cationic charge polarization/local charge availability of the of the ammonium cation of the QAC by at least temporarily sequestering or otherwise withdrawing or complexing the negative counterion of the quaternary ammonium ion. In this context and with reference to urea as an example for a nitrogenous base-hydrochloride, it should be noted that no other form of urea such as pure urea (i.e., no HCl) or a urea dichloride (i.e., two Cl⁻) was shown to increase the cationic charge or charge availability on QACs. Therefore, and as used herein, the phrase “increase the cationic charge” does not refer to an increase in net charge (e.g., from +1 to +2), but to an increase in electrical polarization or local charge availability of the positive charge at the ammonium nitrogen.

In one example of the inventive subject matter, the antiviral composition comprises in an aqueous formulation urea hydrochloride as the nitrogenous base-hydrochloride and dialkyl dimethyl ammonium chloride as the QAC. Most typically, the aqueous formulation uses water as base and includes urea hydrochloride in an amount of about 1.8% (w/w) of the final composition and dialkyl dimethyl ammonium chloride in an amount of about 0.9% (w/w) in the final composition.

Of course, it should be appreciated that the specific amounts of QAC and nitrogenous base-hydrochloride may vary, and the skilled artisan will be readily informed about proper concentrations and ratios by measuring antiviral effect and increased antiviral effect of the combination. Most typically, however, the amount of the nitrogenous base-hydrochloride will be at least 0.001% (w/w), or at least 0.005% (w/w), or at least 0.01% (w/w), or at least 0.05% (w/w), or at least 0.1% (w/w), or at least 0.5% (w/w), or at least 1.0% (w/w), or at least 2.0% (w/w), or at least 3.0% (w/w) of the final formulation. Thus, suitable concentrations of the nitrogenous base-hydrochloride include 0.001-0.01% (w/w), or 0.01-0.1% (w/w), or 0.01-0.1% (w/w), or 0.1-0.5% (w/w), or 0.5-0.75% (w/w), or 0.75-1.0% (w/w), or 1.0-1.5% (w/w), or 1.5-2.0% (w/w), or 1.0-2.5% (w/w), or 2.0-2.5% (w/w), or 2.5-3.0% (w/w), or 0.5-3.0%, and even higher. For example, the nitrogenous base-hydrochloride may be present in the final biocidal composition in an amount of 0.5% (+/−0.2), 0.7% (+/−0.2), 0.9% (+/−0.2), 1.1% (+/−0.2), 1.3% (+/−0.2), 1.5% (+/−0.2), 1.7% (+/−0.2), 1.9% (+/−0.2), or 2.1% (+/−0.2), 2.3% (+/−0.2), 2.5% (+/−0.2), 2.7% (+/−0.2), 2.9% (+/−0.2), 3.1% (+/−0.2), or even higher.

As will be readily appreciated, the type of nitrogenous base-hydrochloride will at least in part determine the desired or optimum concentration of the nitrogenous base-hydrochloride. For example, suitable nitrogenous bases for the nitrogenous base-hydrochloride compounds include urea, acetylurea, alkanolamines, including triethanolamine, diethanolamine, monoethanolamine, various alkoxyamines such as HO-[(alkyl)O]ₓ—CH₂)_{y}—NH₂, including HO—[(CH₂)ₓ O]—CH₂)ₓ—NH₂ (wherein the alkyl group can vary within the moiety, wherein x is typically between 1-8 and wherein y is typically an integer of 1 to 40, various alkylamines such as methylamine, ethylamine, propylamine and butylamine, dialkylamines, alkyldiamines (e.g., ethylenediamine), alkyltriamines, alkyltetramines, and trialkylamines.

Further suitable bases include polymers with amino or (alkyl or aryl)amino substituent groups, including (mono or di)-alkylaminoalkylacrylate, and (mono or di)alkylamino-alkylmethacrylate, polymers with nitrogen-containing heterocyclic groups (e.g., pyridine, pyrimidine, imidazole, tetrazole, pyrazine, quinoline, isoquinoline, indole, isoindole, benzimidazole, purine, pyrrole, is pyrazole, quinazoline, pyridazine, pyrazine, cinnoline, phthalazine, quinoxaline, xanthine, hypoxanthine, and pteridine). In still further contemplated aspects, the nitrogenous base may also be an amide, such as formamide, acetamide, acrylamide, polymers and copolymers of acrylamide, and cyclic amides such as caprolactam; pyrollidone, polyvinyl pyrollidone, copolymers of vinyl pyrollidone, methacrylamide, polymethacrylamide, copolymers of methacrylamide, ammonia, guanidine, hydroxyurea, semicarbazide; mono-, di-, or tri(alkyl or aryl)urea, and wherein in the case of di(alkyl or aryl)urea the alkyl or aryl groups can be on the same or different nitrogen atoms, O-methyl hydroxyl amine (methoxylamine), aniline, and hydrazine.

It is further contemplated that suitable nitrogenous bases are reacted with a strong acid, preferably HCl (muriatic acid) to so form the nitrogenous base-hydrochloride. In general, it is preferred that the molar ratio between the strong acid and the nitrogenous base will be between 0.01 and 10, or between 0.5 and 5, or between 0.7 to 2.5. For example, suitable ratios between the strong acid and the nitrogenous base will be about 0.5:1, about 0.7:1, about 1:1, about 1.3:1, about 1.5:1, about 1.7:1, about 2.0:1, about 2.3:1, about 2.7:1, or about 3.0:1. Most typically the molar ratio between the strong acid and the nitrogenous base will be between 1:1 and 2:1.

With respect to the QAC suitable for use herein, it should be appreciated that most QACs are deemed appropriate, and all QACs with at least some antiviral activity are contemplated. Further preferred QACs include those with moderate to low contact toxicity and those that are environmentally friendly. For example, suitable QACs with excellent biocidal activity against a large variety of viruses, bacteria, germs, fungi, mould, and mildew include alkyl dimethyl benzyl ammonium chloride, alkyl dimethyl ethyl benzyl ammonium chloride, didecyl dimethyl ammonium chloride, benzethonium chloride, myristyl ammonium chloride, dialkyl dimethyl ammonium chloride, and dialkyl methyl benzyl ammonium chloride, and all reasonable mixtures thereof.

Depending on the particular type of QAC used, the amount of the QAC may vary considerably. However, it is generally preferred that the QAC will be present in an amount of at least 0.0005% (w/w), or at least 0.001% (w/w), or at least 0.005% (w/w), or at least 0.01% (w/w), or at least 0.05% (w/w), or at least 0.1% (w/w), or at least 0.5% (w/w), or at least 1.0% (w/w), or at least 2.0% (w/w), or at least 3.0% (w/w) of the final formulation. Thus, suitable concentrations of the QAC include 0.001-0.01% (w/w), or 0.01-0.1% (w/w), or 0.01-0.1% (w/w), or 0.1-0.5% (w/w), or 0.5-0.75% (w/w), or 0.75-1.0% (w/w), or 1.0-1.5% (w/w), or 1.5-2.0% (w/w), or 2.0-2.5% (w/w), or 2.5-3.0% (w/w), or 0.5-3.0% (w/w), and even higher. For example, the QAC may be present in the final biocidal composition in an amount of 0.5% (+/−0.2), 0.7% (+/−0.2), 0.9% (+/−0.2), 1.1% (+/−0.2), 1.3% (+/−0.2), 1.5% (+/−0.2), 1.7% (+/−0.2), 1.9% (+/−0.2), or 2.1% (+/−0.2), 2.3% (+/−0.2), 2.5% (+/−0.2), 2.7% (+/−0.2), 2.9% (+/−0.2), 3.1% (+/−0.2), or even higher.

Moreover, it should be appreciated that while the preferred solvent for the QAC compound with a reagent that will increase the cationic charge on the QAC compound is water, various other solvents are also deemed appropriate for use herein and especially include polar protic and polar aprotic solvents. Most typically, the non-water solvents will be used as co-solvents that form a single-phase mixture. Moreover, in more uses the co-solvent will be a minority component in the solvent mixture. For example, where a short chain alcohol, DMF, THF, or methylene chloride are used as co-solvent, the co-solvent will be present in an amount of equal or less than 25% (w/w), or equal or less than 20% (w/w), or equal or less than 15% (w/w), or equal or less than 10% (w/w), or equal or less than 5% (w/w), or less.

The inventor further postulates that the biocidal activity is at least in part driven by the cationic charge in the QAC compounds as such compounds are able to penetrate the cell membrane or protein envelope of a virus, bacteria, etc. The QAC cation inserts into the liquid bilayer or hydrophobic envelope of the cell and thereby induces structural changes in the bilayer or envelope, resulting in loss of barrier function that leads to metabolic and/or structural damage to the virus or cell. Thus, where the cationic charge of the QAC is enhanced as noted above, the faster the virus or other pathogen cell is rendered inactive. Therefore, it should be appreciated that the need for combination of diverse QACs is no longer present as QAC activity can be enhanced using the reagent that will increase the cationic charge on the QAC compound. Similarly, even where a single QAC is used, it should be appreciated that the concentration of the QAC needed to achieve a particular biocidal effect can be advantageously and significantly reduced when a nitrogenous base-hydrochloride is present.

### Examples

Urea Hydrochloride: Urea is weakly basic, forming salts with strong acids. Urea hydrochloride is a salt formed from a mixture of urea with hydrochloric acid. Commercially available urea hydrochloride salts include the 1:1 urea to hydrochloric acid salt (CAS 506-89-8), and the 1:2 urea to hydrochloric acid salt (dihydrochloride or dichloride). For example, the 1:1 urea hydrochloric acid salt is sold by Esprit Chemical Company (Rockland, Mass.). Any desired ratio of urea to hydrochloric acid that performs the desired function can be prepared by simply mixing the appropriate ratios of components, typically in water. Any amount of urea hydrochloride can be used in the methods described herein, with any molar ratio of urea and hydrochloric acid, that performs the desired function. The preferred composition is a solution of hydrochloric acid and urea combined in a molar ratio of at least approximately one mole of urea to one mole of hydrochloric acid, or a slight excess of urea, in water.

Exemplary preparation of Urea Hydrochloric Acid 1:1 Salt: To muriatic acid (65 parts of 20 degree baume (31.45% minimum, 32.5% average by weight)) was added prilled urea (35 parts). The mixture was stirred at room temperature, during which time a slight exotherm occurred.

Preparation of Urea Hydrochloric Acid 2:1 Salt (dihydrochloride): To muriatic acid (130 parts of 20 degree baume (31.45% is minimum, 32.5% average by weight)) is added prilled urea (35 parts). The mixture is stirred at room temperature, during which time a slight exotherm occurs.

In general, it is recommended that the desired salt, as opposed to the individual components, be added to aqueous solutions to avoid a dilution effect, as well as corrosivity and safety problems associated with addition of the strong acid in the uncomplexed form.

Preparation of a QAC-urea hydrochloride solution: The inventor has discovered that the cationic charge character of an individual QAC or of a combination of biocidal QAC's can be increased by providing in the water-based solution a minimum of 5 ppm of urea monohydrochloride or other nitrogenous base-hydrochloride. However, more typically the urea monohydrochloride or other nitrogenous base-hydrochloride is present in an amount of between 0.5 to 5.0% (e.g., 0.9%, or 1.8%, or 3%) in the final formulation of the composition that comprises the QAC. For example, and as is shown in more detail below, the experimental data indicate that urea monohydrochloride or other nitrogenous base-hydrochloride can boost the cationic charge character to a level such that 0.9% of DDAC (didecyl dimethyl ammonium chloride) in combination with the urea or other nitrogenous base-hydrochloride in water has the same biocidal effect as 3% DDAC alone in water.

Test Solutions and Tests: To prepare the various QAC solutions, the following materials where used: Stepan BTC 1010 (50% aqueous solution of didecyl dimethyl ammonium chloride) and Stepan BTC 12 Special (50% aqueous solution of alkyl dimethyl benzyl ammonium chloride). Urea Monohydrochloride was prepared by reacting solid urea with hydrochloric acid 20BE (32% aqueous solution) at a ratio of one Mol active HCl to one Mol urea. Both Urea and HCl 20 BE are readily commercially available.

Biological testing: Gloeocapsa magma was chosen as a bacterial species that served as a model system for corona virus in terms of surface adhesion and membrane characteristics. The bacteria were cultured in a petri dish and inoculated on plywood panels (10×10 cm). After 4 weeks of incubation (as per ASTM 4445-84), the panels showed a consistent and homogenous coverage of green growth. The panels were dipped in the testing solutions for 10 seconds and left to dry. 24 hours post immersion each panel was examined for presence of green (living bacteria). This was done visually and rated from 0 (no growth)) to 5 (full growth coverage).

Single QAC: Testing Solutions were prepared by dissolving DDAC in deionized water at the same total concentrations as for the combination test below: 0.5%, 1%, 1.5%, 2.0%, 2.5%, 3.0%, and 3.5% as listed in Table A (solutions 8 to 14). Also shown in Table A is the visual rating of microbial growth from 0 (no growth)) to 5 (full growth). FIG. 1 depicts the same results in bar graph format.

TABLE A

| | 0.5% | 1.0% | 1.5% | 2.0% | 2.5% | 3.0% | 3.5% |
|---|---|---|---|---|---|---|---|
| Solution | QAC | QAC | QAC | QAC | QAC | QAC | QAC |
| 8 | 5 | — | — | — | — | — | — |
| 9 | — | 5 | — | — | — | — | — |
| 10 | — | — | 4 | — | — | — | — |
| 11 | — | — | — | 3 | — | — | — |
| 12 | — | — | — | — | 2 | — | — |
| 13 | — | — | — | — | — | 0 | — |
| 14 | — | — | — | — | — | — | 0 |

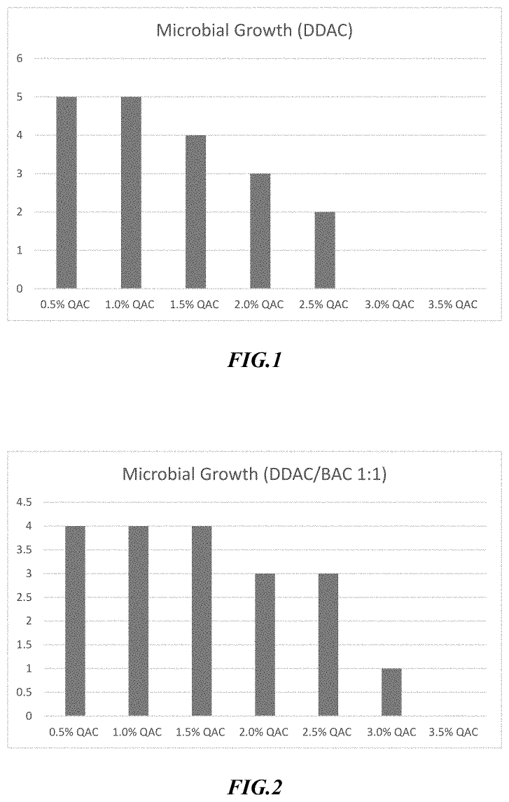

Combination of two QAC compounds: The following test solutions were prepared by dissolving DDAC (didecyl dimethyl ammonium chloride) and BAC (benzalkonium chloride) at a ratio of 1:1 (w/w) in deionized water as follows and shown in Table B. (1) A solution of QAC in deionized water, total concentration of the QACs in solution was 0.5% (w/w). (2) A solution with a total concentration of the QACs was 1.0% (w/w). (3) A solution with a total concentration of the QACs was 1.5% (w/w). (4) A solution with a total concentration of the QACs was 2.0% (w/w). (5) A solution with a total concentration of the QACs was 2.5% (w/w). (6) A solution with a total concentration of the QACs was 3.0% (w/w). (7) A solution with a total concentration of QAC was 3.5% (w/w). Also shown in Table B is the visual rating of microbial growth from 0 (no growth)) to 5 (full growth). FIG. 2 depicts the same results in bar graph format.

TABLE B

| | 0.5% | 1.0% | 1.5% | 2.0% | 2.5% | 3.0% | 3.5% |
|---|---|---|---|---|---|---|---|
| Solution | QAC | QAC | QAC | QAC | QAC | QAC | QAC |
| 1 | 4 | — | — | — | — | — | — |
| 2 | — | 4 | — | — | — | — | — |
| 3 | — | — | 4 | — | — | — | — |
| 4 | — | — | — | 3 | — | — | — |
| 5 | — | — | — | — | 3 | — | — |
| 6 | — | — | — | — | — | 1 | — |
| 7 | — | — | — | — | — | — | 0 |

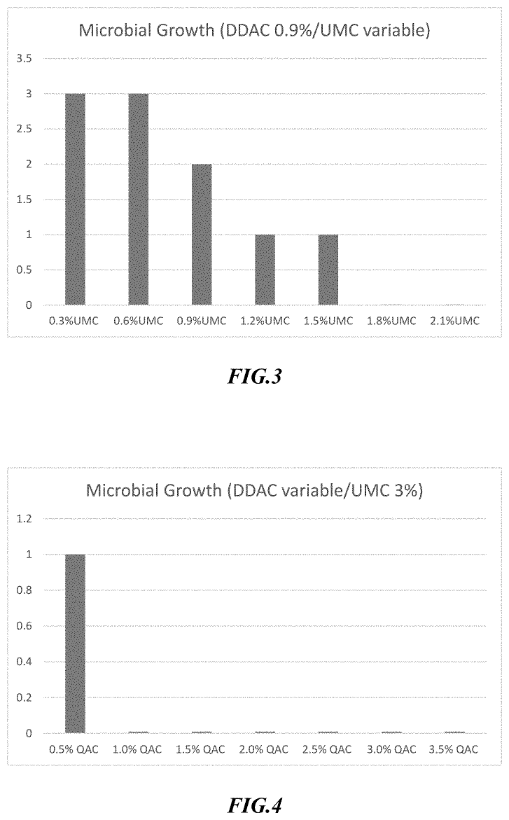

Urea HCl-QAC combination (I): Test solutions were prepared by dissolving DDAC in water-based solutions of 3% (w/w) Urea Monohydrochloride (UMC) as follows and as shown in Table C below. (15) A solution with a total concentration of DDAC was 0.5% (w/w). (16) A solution with a total concentration of DDAC was 1.0% (w/w). (17) A solution with a total concentration of DDAC was 1.5% (w/w). (18) A solution with a total concentration of DDAC was 2.0% (w/w). (19) A solution with a total concentration of DDAC was 2.5% (w/w). (20) A solution with a total concentration of DDAC was 3.0% (w/w). (21) A solution with a total concentration of DDAC was 3.5% (w/w). Also shown in Table C is the visual rating of microbial growth from 0 (no growth)) to 5 (full growth). FIG. 3 depicts the same results in bar graph format.

TABLE A

| | 0.5% | 1.0% | 1.5% | 2.0% | 2.5% | 3.0% | 3.5% |
|---|---|---|---|---|---|---|---|
| Solution | QAC | QAC | QAC | QAC | QAC | QAC | QAC |
| 15 | 1 | — | — | — | — | — | — |
| 16 | — | 0 | — | — | — | — | — |
| 17 | — | — | 0 | — | — | — | — |
| 18 | — | — | — | 0 | — | — | — |
| 19 | — | — | — | — | 0 | — | — |
| 20 | — | — | — | — | — | 0 | — |
| 21 | — | — | — | — | — | — | 0 |

Urea HCl-QAC combination (II): Test solutions were prepared by dissolving 0.9% (w/w) DDAC in deionized water Urea Monohydrochloride (UMC) solutions as follows and shown in Table D. (22) 0.3% (w/w) UMC. (23) 0.6% (w/w) UMC. (24) 0.9% (w/w) UMC. (25) 1.2% (w/w) UMC. (26) 1.5% (w/w) UMC. (27) 7. 1.8% (w/w) UMC. (28) 28. 2.1% (w/w) UMC. Also shown in Table D is the visual rating of microbial growth from 0 (no growth)) to 5 (full growth). FIG. 4 depicts the same results in bar graph format.

TABLE B

| | 0.3% | 0.6% | 0.9% | 1.2% | 1.5% | 1.8% | 2.1% |
|---|---|---|---|---|---|---|---|
| Solution | UMC | UMC | UMC | UMC | UMC | UMC | UMC |
| 22 | 3 | — | — | — | — | — | — |
| 23 | — | 3 | — | — | — | — | — |
| 24 | — | — | 2 | — | — | — | — |
| 25 | — | — | — | 1 | — | — | — |
| 26 | — | — | — | — | 1 | — | — |
| 27 | — | — | — | — | — | 0 | — |
| 28 | — | — | — | — | — | — | 0 |

Further tests (data not shown) in which the QAC or a QAC mixture at concentrations as noted above was combined with urea (no HCl) at concentrations as noted above only yielded results that were substantially the same as those listed in Tables A and B above. Likewise, where the molar ratio of urea to hydrochloric acid was 1:2 (urea dihydrochloride), the results were once more substantially the same as those listed in Tables A and B above. Therefore, it should be appreciated that since urea (no Hydrochloride) and urea dihydrochloride had no impact in biocidal activity when combined with DDAC and/or BAC, a synergistic effect between UMC and a QAC with respect to biocidal activity was readily apparent. The tests further confirmed that the cationic charge had a proportional influence on the biocidal impact on QAC's. Consequently, it should be appreciated that an increase in cationic charge increased the biocidal effectiveness of a QAC and especially DDAC, and that addition of UMC to cationic solutions of QACs affords increased biocidal power of QACs, even when QACs are used at relatively low concentrations.

In some embodiments, the numbers expressing quantities of ingredients, properties such as concentration, reaction conditions, and so forth, used to describe and claim certain embodiments of the invention are to be understood as being modified in some instances by the term “about.” Accordingly, in some embodiments, the numerical parameters set forth in the written description and attached claims are approximations that can vary depending upon the desired properties sought to be obtained by a particular embodiment. The recitation of ranges of values herein is merely intended to serve as a shorthand method of referring individually to each separate value falling within the range. Unless otherwise indicated herein, each individual value is incorporated into the specification as if it were individually recited herein. Moreover, and unless otherwise indicated herein, all percentage values are by weight (w/w).

All methods described herein can be performed in any suitable order unless otherwise indicated herein or otherwise clearly contradicted by context. The use of any and all examples, or exemplary language (e.g. “such as”) provided with respect to certain embodiments herein is intended merely to better illuminate the invention and does not pose a limitation on the scope of the invention otherwise claimed. No language in the specification should be construed as indicating any non-claimed element essential to the practice of the invention.

As used in the description herein and throughout the claims that follow, the meaning of “a,” “an,” and “the” includes plural reference unless the context clearly dictates otherwise. Also, as used in the description herein, the meaning of “in” includes “in” and “on” unless the context clearly dictates otherwise. As also used herein, and unless the context dictates otherwise, the term “coupled to” is intended to include both direct coupling (in which two elements that are coupled to each other contact each other) and indirect coupling (in which at least one additional element is located between the two elements). Therefore, the terms “coupled to” and “coupled with” are used synonymously.

It should be apparent to those skilled in the art that many more modifications besides those already described are possible without departing from the inventive concepts herein. The inventive subject matter, therefore, is not to be restricted except in the scope of the appended claims. Moreover, in interpreting both the specification and the claims, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced. Where the specification claims refers to at least one of something selected from the group consisting of A, B, C . . . and N, the text should be interpreted as requiring only one element from the group, not A plus N, or B plus N, etc.

What is claimed is:

1. A biocidal composition, comprising:
an aqueous carrier comprising a synergistic combination of a quaternary ammonium compound (QAC) and a nitrogenous base-hydrochloride;
wherein the nitrogenous base-hydrochloride is present in an amount relative to the QAC that increases a biocidal effect as compared to the biocidal effect of the QAC alone.

2. The biocidal composition of claim 1 wherein the QAC is present in the composition in an amount of between 0.5% and 3%, and wherein the nitrogenous base-hydrochloride is present in the composition in an amount of between 1.0% and 2.5%.

3. The biocidal composition of claim 1 wherein the QAC is present in the composition in an amount of 0.9% (+/−0.2) %, and wherein the nitrogenous base-hydrochloride is present in the composition in an amount of at least 1.8%.

4. The biocidal composition of claim 1, wherein the QAC is selected from the group consisting of alkyl dimethyl benzyl ammonium chloride, alkyl dimethyl ethyl benzyl ammonium chloride, didecyl dimethyl ammonium chloride, benzethonium chloride, myristyl ammonium chloride, dialkyl dimethyl ammonium chloride, and dialkyl methyl benzyl ammonium chloride.

5. The biocidal composition of claim 1, wherein the QAC is dialkyl dimethyl ammonium chloride.

6. The biocidal composition of claim 1, wherein the nitrogenous base in the nitrogenous base-hydrochloride is urea, acetylurea, an alkanolamine, an alkoxyamines, an alkylamine, a dialkylamine, an alkyldiamine, an alkyltriamine, an alkyltetramine, and/or a trialkylamine.

7. The biocidal composition of claim 1, wherein the nitrogenous base-hydrochloride is urea-hydrochloride.

8. The biocidal composition of claim 1, wherein the amount of the nitrogenous base-hydrochloride that increases a biocidal effect of the QAC is between 0.75 and 3%.

9. The biocidal composition of claim 1, wherein the aqueous carrier is water and further comprises a viscosity enhancing agent and/or an anionic or zwitterionic detergent.

10. The biocidal composition of claim 1, wherein the composition is formulated for topical application to a fomite via a spray.

11. The biocidal composition of claim 1, wherein the biocidal effect of the composition is reduced by no more than 10% after storage of the composition over at least one year.

12. The biocidal composition of claim 1, wherein the biocidal effect is an antiviral and/or an antibacterial effect.

13. The biocidal composition of claim 1, further comprising an organic cosolvent.

14. The biocidal composition of claim 1, contained in a multi-use container having a volume of between 100 mL and 5,000 mL, and optionally comprising a spray nozzle.

15. A method of disinfecting a surface, comprising a step of applying the composition of claim 1 to the surface in an amount effective to reduce a quantity of infectious bacteria or viruses.

16. The method of claim 15, wherein the step of applying comprises spraying, soaking, or wiping the composition onto the surface.

17. A method of increasing a biocidal effect of a quaternary ammonium compound (QAC), comprising a step of combining the QAC with a nitrogenous base-hydrochloride that increases the cationic charge on the QAC.

18. The method of claim 17, wherein the nitrogenous base in the nitrogenous base-hydrochloride is urea, acetylurea, an alkanolamine, an alkoxyamines, an alkylamine, a dialkylamine, an alkyldiamine, an alkyltriamine, an alkyltetramine, and/or a trialkylamine.

19. The method of claim 17, wherein the QAC is selected from the group consisting of alkyl dimethyl benzyl ammonium chloride, alkyl dimethyl ethyl benzyl ammonium chloride, didecyl dimethyl ammonium chloride, benzethonium chloride, myristyl ammonium chloride, dialkyl dimethyl ammonium chloride, and dialkyl methyl benzyl ammonium chloride, and wherein the reagent is urea, acetylurea, an alkanolamine, an alkoxyamines, an alkylamine, a dialkylamine, an alkyldiamine, an alkyltriamine, an alkyltetramine, and/or a trialkylamine.

20. The method of claim 17, wherein the nitrogenous base-hydrochloride is present in an amount relative to the QAC that increases a biocidal effect as compared to the biocidal effect of the QAC alone.
